(19) United States
(12) Patent Application Publication
(10) Pub. No.: US 2007/0112082 A1
(43) Pub. Date: May 17, 2007

(54) Moldable-foam moldings composed of expandable pelletized filled polymer materials

(75) Inventors: Klaus Hahn, Kirchheim (DE); Gerd Ehrmann, Deidesheim (DE); Joachim Ruch, Wachenheim (DE); Markus Allmendinger, Meckenheim (DE); Bernhard Schmied, Frankenthal (DE); Klaus Muhlbach, Grunstadt (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, LUDWIGSHAFEN GERMANY (DE)

(21) Appl. No.: 10/581,679

(22) PCT Filed: Dec. 3, 2004
(86) PCT No.: PCT/EP04/13748

§ 371 Date: Jun. 6, 2006

(30) Foreign Application Priority Data
Dec. 12, 2003 (DE) 103-58-786.1

(51) Int. Cl. C08J 9/00

(52) U.S. Cl. 521/60

(57) ABSTRACT

Moldable-foam moldings whose density is in the range from 8 to 200 g/l, obtainable via fusion of prefoamed foam beads composed of expandable pelletized filled thermoplastic polymer materials, and a process for preparing the expandable pelletized polymer materials.

The invention relates to moldable-foam moldings whose density is in the range from 8 to 200 g/l, obtainable via fusion of prefoamed foam beads composed of expandable pelletized filled thermoplastic polymer materials, and a process for preparing the expandable pelletized polymer materials.

A process for preparing expandable styrene polymers, such as expandable polystyrene (EPS) via suspension polymerization has been known for a long time. A disadvantage of these processes is that large amounts of waste water arise and have to be discarded. The polymers have to be dried in order to remove internal water. In addition, the suspension polymerization generally gives broad bead size distributions which require complicated sieving to give various bead fractions.

Extrusion processes can also be used to prepare expanded and expandable styrene polymers. Here, the blowing agent is incorporated by mixing, by way of example, through an extruder into the polymer melt, and the material is passed through a die plate and divided to give particles or strands (U.S. Pat. No. 3,817,669, GB 1,062,307, EP-B 0 126 459, U.S. Pat. No. 5,000,891).

EP-A 668 139 describes a process for the cost-effective preparation of expandable pelletized polystyrene material (EPS) where static mixing elements are used to prepare the melt comprising blowing agent in a dispersion, retention, and cooling stage, and the material is then pelletized. The dissipation of large amounts of heat is required, because the melt is cooled to a few degrees above the solidification point.

Various pelletization processes have been proposed for substantial prevention of post-extrusion foaming, e.g. underwater pelletization (EP-A 305 862), spray mist (WO 03/053651), or atomization (U.S. Pat. No. 6,093,750).

DE 198 19 058 describes expandable styrene polymers which have undergone slight incipient foaming, which via extrusion of a melt of polystyrene comprising blowing agent and underwater pelletization in a waterbath with a temperature of from 50 to 90° C., the pressure being from 2 to 20 bar.

GB 1 048 865 describes extruded polystyrene foams with high filler content in the form of sheets, strips, or ribbons with densities in the range from 100 to 1100 kg/m³. Here, polystyrene comprising blowing agent is premixed with the fillers and charged to an extruder. There is no description of expandable styrene or of moldable polystyrene foams with high filler content.

WO 03/035728 describes the production of expandable polystyrene which an inorganic filler with an average diameter in the range from 0.01 to 100 μm, with a refractive index above 1.6 and a color index of 22 or below. The examples used from 1 to 4% by weight of TiO₂ as replacement for IR absorber, such as graphite, in order to reduce the thermal conductivity of the foams.

Expandable styrene polymers comprising halogen-free flame retardants are known. According to EP-A 0 834 529, the flame retardant used comprises at least 12% by weight of a mixture composed of a phosphorus compound and of a metal hydroxide which eliminates water, for example triphenyl phosphate and magnesium hydroxide, in order to obtain foams which pass the DIN 4102 B2 fire test.

WO 00/34342 describes expandable styrene polymers which comprise, as flame retardant, from 5 to 50% by weight of expandable graphite and also, if appropriate, from 2 to 20% by weight of a phosphorus compound.

WO 98/51735 describes expandable styrene polymers comprising graphite particles and having reduced thermal conductivity, and obtainable via suspension polymerization or via extrusion in a twin-screw extruder. Because of the high shear forces in a twin-screw extruder, significant molecular weight degradation of the polymer used, and/or some decomposition of added additives, such as flame retardant, is/are usually observed.

Factors of decisive importance for giving the foams ideal insulation properties and good surfaces are the number of cells and the foam structure obtained during foaming of the expandable styrene polymers (EPSs). The pelletized EPS materials prepared via extrusion are frequently not capable of foaming to give foams with ideal foam structure.

It is also known that inorganic substances, such as talc, carbon black, graphite, or glass fibers, can be admixed in small amounts with polymers for nucleation in foaming processes. At higher concentrations, the result is generally open-cell foams. For example, EP-A 1 002 829 describes the suspension polymerization of styrene in the presence of silylated glass fibers to give EPS beads which are processed to give an open-cell foam.

When preparing expandable polystyrene via suspension polymerization, the process often has to be modified for the particular additives used, in order to avoid coagulation. So that the physical properties of foams can be modified as desired, and also so that materials can be expanded, giving associated savings in plastics usage, it would be desirable to gain access in a simple manner to expandable pelletized thermoplastic polymer materials with large amounts of filler.

It was an object of the present invention to provide expandable pelletized thermoplastic polymer materials which, at high filler contents, can be prefoamed to give predominantly closed-cell foam beads, and can be fused to give moldable-foam moldings whose density is in the range from 8 to 200 g/l.

This has led to the discovery of moldable-foam moldings obtainable via fusion of prefoamed foam beads composed of expandable pelletized filled thermoplastic polymer materials, where the density of the moldable foam is in the range from 8 to 200 g/l, preferably in the range from 10 to 50 g/l.

Surprisingly, despite the presence of fillers, the inventive moldable-foam moldings have a high proportion of closed cells, more than 60%, preferably more than 70%, particularly preferably more than 80%, of the cells of the individual foam beads generally being of closed-cell type.

Fillers which may be used are organic and inorganic powders or fibers, and also mixtures of these. Examples of organic fillers which may be used are wood flour, starch, flax fibers, hemp fibers, ramie fibers, jute fibers, sisal fibers, cotton fibers, cellulose fibers, or aramid fibers. Examples of inorganic fillers which may be used are carbonates, silicates, barium sulfate, glass beads, zeolites, or metal oxides. Preference is given to pulverulent inorganic substances, such as talc, chalk, kaolin (Al₂(Si₂O₅)(OH)₄), aluminum hydroxide, magnesium hydroxide, aluminum nitrite, aluminum silicate, barium sulfate, calcium carbonate, calcium sulfate, silica, powdered quartz, Aerosil, alumina, or wollastonite, or inorganic substances in bead or fiber form, e.g. glass beads, glass fibers, or carbon fibers.

The average particle diameter, or in the case of fibrous fillers the length, should be in the region of the cell size or smaller. Preference is given to an average particle diameter in the range from 1 to 100 μm, preferably in the range from 2 to 50 μm.

Particular preference is given to inorganic fillers with a density in the range from 2.0 to 4.0 g/cm³, in particular in the range from 2.5 to 3.0 g/cm³. The whiteness/brightness (DIN/ISO) is preferably from 50 to 100%, in particular from 70 to 98%. The ISO 787/5 oil number of the preferred fillers is in the range from 2 to 200 g/100 g, in particular in the range from 5 to 150 g/100 g

The properties of the expandable thermoplastic polymers and of the moldable-foam moldings obtainable thereform can be influenced via the nature and amount of the fillers. The proportion of the filler is generally in the range from 1 to 50% by weight, preferably in the range from 5 to 30% by weight, based on the thermoplastic polymer. In the case of filler contents in the range from 5 to 15% by weight, no substantial impairment of the mechanical properties of the moldable-foam moldings is observed, e.g. flexural strength or compressive strength. Adhesion promoters, such as maleic-anhydride-modified styrene copolymers, polymers containing epoxy groups, organosilanes, or styrene copolymers having isocyanate groups or having acid groups can be used for marked improvement of the bonding of the filler to the polymer matrix and thus improvement of the mechanical properties of the moldable-foam moldings.

Inorganic fillers generally reduce combustibility. Fire performance can in particular be markedly improved via addition of inorganic powders, such as aluminum hydroxide.

Surprisingly, even at high filler contents, the inventive pelletized thermoplastic polymer materials exhibit very little loss of blowing agent during storage. The nucleating action also permits a reduction in the content of blowing agent, based on the polymer.

Examples of thermoplastic polymers which may be used are styrene polymers, polyamides (PAs), polyolefins, such as polypropylene (PP), polyethylene (PE), or polyethylene-propylene copolymers, polyacrylates, such as polymethyl methacrylate (PMMA), polycarbonate (PC), polyester, such as polyethylene terephthalate (PET) or polybutylene terephthalate (PBT), polyether sulfones (PESs), polyether ketones, or polyether sulfides (PESs), or mixtures of these. Styrene polymers are particularly preferably used.

It has been found that styrene polymers whose molecular weights M_{w} are below 160 000 lead to polymer abrasion during pelletization. The molar mass of the expandable styrene polymer is preferably from 190 000 to 400 000 g/mol, particularly preferably in the range from 220 000 to 300 000 g/mol. The molar mass of the expandable polystyrene is generally below the molar mass of the polystyrene used by about 10 000 g/mol, because molecular weight is reduced via shear and/or exposure to heat.

To minimize the size of pellets obtained, die swell after discharge from the die should be minimized. It has been found that die swell can be influenced, inter alia, via the molecular weight distribution of the styrene polymer. The expandable styrene polymer should therefore preferably have a molecular weight distribution whose polydispersity M_{w}/Mₙ is at most 3.5, particularly preferably in the range from 1.5 to 2.8, and very particularly preferably in the range from 1.8 to 2.6.

Styrene polymers preferably used are glass-clear polystyrene (GPPS), impact-resistant polystyrene (HIPS), anionically polymerized polystyrene or impact-resistant polystyrene (AIPS), styrene-α-methylstyrene copolymers, acrylonitrile-butadiene-styrene polymers (ABS), styrene-acrylonitrile (SAN), acrylonitrile-styrene-acrylate (ASA), methacrylate-butadiene-styrene (MBS), methyl methacrylate-acrylonitrile-butadiene-styrene (MABS) polymers, or mixtures of these or with polyphenylene ether (PPE).

In order to improve mechanical properties or thermal stability, the styrene polymers mentioned may be blended with thermoplastic polymers, such as polyamides (PAs), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfones (PES), polyether ketones or polyether sulfides (PES) or mixtures of these, generally in total proportions up to a maximum of 30% by weight, preferably in the range from 1 to 10% by weight, based on the polymer melt, where appropriate with use of compatibilizers. Mixtures within the ranges of amounts mentioned are also possible with, by way of example, hydrophobically modified or functionalized polymers or oligomers, rubbers, such as polyacrylates or polydienes, e.g. styrene-butadiene block copolymers, or biodegradable aliphatic or aliphatic/aromatic copolyesters.

Examples of suitable compatibilizers are maleic-anhydride-modified styrene copolymers, polymers containing epoxy groups, and organosilanes.

Recycled polymers comprising the thermoplastic polymers mentioned, in particular styrene polymers and expandable styrene polymers (EPSs) may also be admixed with the styrene polymer melt in amounts which do not substantially impair its properties, generally in amounts of at most 50% by weight, in particular in amounts of 1 to 20% by weight.

The styrene polymer melt comprising blowing agent generally comprises one or more blowing agents homogeneously distributed in a total proportion of from 2 to 10% by weight, preferably from 3 to 7% by weight, based on the styrene polymer melt comprising blowing agent. Suitable blowing agents are the physical blowing agents usually used in EPS, such as aliphatic hydrocarbons having from 2 to 7 carbon atoms, alcohols, ketones, ethers, or halogenated hydrocarbons. Preference is given to use of isobutane, n-butane, isopentane, n-pentane.

To improve foamability, finely dispersed droplets of internal water may be introduced into the styrene polymer matrix. An example of the method for this is the addition of water into the molten styrene polymer matrix. The location of addition of the water may be upstream of, together with, or downstream of, the blowing agent feed. Homogeneous distribution of the water may be achieved by using dynamic or static mixers.

An adequate amount of water, based on the styrene polymer, is generally from 0 to 2% by weight, preferably from 0.05 to 1.5% by weight.

Expandable styrene polymers (EPSs) with at least 90% of the internal water in the form of droplets of internal water with diameter in the range from 0.5 to 15 μm form, on foaming, foams with an adequate number of cells and with homogeneous foam structure.

The amount added of blowing agent and of water is selected in such a way that the expansion capability a of the expandable styrene polymers (EPSs), defined as bulk density prior to foaming/bulk density after foaming, is at most 125, preferably from 25 to 100.

The bulk density of the inventive expandable pelletized styrene polymer materials (EPSs) is generally at most 700 g/l preferably in the range from 590 to 660 g/l. If fillers are used, bulk densities in the range from 590 to 1200 g/l may arise, depending on the nature and amount of the filler.

Additives, nucleating agents, plasticizers, flame retardants, soluble and insoluble inorganic and/or organic dyes and pigments, e.g. IR absorbers, such as carbon black, graphite, or aluminum powder may moreover be added, in addition to the fillers, together or with spatial separation, to the styrene polymer melt, e.g. by way of mixers or ancillary extruders. The amounts added of the dyes and pigments are generally in the range from 0.01 to 30% by weight, preferably in the range from 1 to 5% by weight. For homogeneous and microdisperse distribution of the pigments within the styrene polymer, it can be advantageous, particularly in the case of polar pigments, to use a dispersing agent, e.g. organosilanes, polymers containing epoxy groups, or maleic-anhydride-grafted styrene polymers. Preferred plasticizers are mineral oils, low-molecular-weight styrene polymers, and phthalates, and these may be used in amounts of from 0.05 to 10% by weight, based on the styrene polymer.

Fillers with particle sizes in the range from 0.1 to 100 μm, in particular in the range from 0.5 and 10 μm, lower the thermal conductivity of the polystyrene foam by from 1 to 3 mW at contents of 10% by weight. This means that comparatively low thermal conductivities can be achieved even with relatively small amounts and with IR absorbers, such as carbon black and graphite.

To reduce thermal conductivity, it is preferable to use amounts of from 0.1 to 10% by weight, in particular amounts of from 2 to 8% by weight, of an IR absorber, such as carbon black or graphite

If use is made of relatively small amounts of fillers, e.g. below 5% by weight, it is also possible to use amounts of from 1 to 25% by weight, preferably in the range from 10 to 20% by weight, of carbon black. At these high carbon black contents, the carbon black is preferably mixed in portions into the styrene polymer melt, by way of the main extruder and an ancillary extruder. Addition by way of an extruder permits simple comminution of the carbon black agglomerates to an average agglomerate size in the range from 0.3 to 10 μm, preferably in the range from 0.5 to 5 μm, and homogeneous coloration of the expandable pelletized styrene polymer materials, which can be foamed to give closed-cell moldable foams with a density in the range from 5 to 40 kg/M³, in particular from 10 to 15 kg/M³. The moldable foams obtainable using from 10 to 20% by weight of carbon black achieve, after foaming and sintering, a thermal conductivity A in the range from 30 to 33 mW/mK, determined at 10° C. to DIN 52612.

It is preferable to use carbon black with an average primary particle size in the range from 10 to 300 nm, in particular in the range from 30 to 200 nm. The BET surface area is preferably in the range from 10 to 120 m²/g.

The graphite used preferably comprises graphite with an average particle size in the range from 1 to 50 μm.

Expandable pelletized styrene polymer materials with reduced thermal conductivity preferably comprise
a) from 5 to 50% by weight of a filler selected from pulverulent inorganic substances, such as talc, chalk, kaolin, aluminum hydroxide, titanium dioxide, chalk, aluminum nitrite, aluminum silicate, barium sulfate, calcium carbonate, calcium sulfate, kaolin, silica, powdered quartz, Aerosil, alumina, or wollastonite and
b) from 0.1 to 10% by weight of carbon black or graphite.

The pelletized EPS material particularly preferably comprises, as flame retardant, hexabromocylododecane (HBCD), and, as flame retardant synergist, dicumyl or dicumyl peroxide. The ratio by weight of flame retardant synergist to organic bromine compound is generally in the range from 1 to 20, preferably in the range from 2 to 5.

Particularly when using carbonates, such as chalk, as filler, the hydrogen halides liberated by halogenated flame retardants, such as HBDC, are neutralized and corrosion of plants during processing is eliminated or reduced.

Inventive expandable pelletized styrene polymer materials rendered flame-retardant without use of halogenated flame retardants preferably comprise
a) from 5 to 50% by weight of a filler, selected from pulverulent inorganic substances, such as talc, chalk, kaolin, aluminum hydroxide, aluminum nitrite, aluminum silicate, barium sulfate, calcium carbonate, titanium dioxide, chalk, calcium sulfate, kaolin, silica, powdered quartz, Aerosil, alumina, or wollastonite, and
b) from 2 to 40% by weight of expandable graphite with an average particle size in the range from 10 to 1000 μm,
c) from 0 to 20% by weight of red phosphorus or an organic or inorganic phosphate, phosphite or phosphonate,
d) from 0 to 10% by weight of carbon black or graphite.

The synergistic action of fillers, such as chalk with expandable graphite and red phosphorus or with a phosphorus compound permits achievement of low-cost, halogen-free flame retardancy.

Preferred expandable pelletized styrene polymer materials rendered flame-retardant without use of halogenated flame retardants comprise, in addition to the fillers and expandable graphite, from 1 to 10% by weight of red phosphorus, triphenyl phosphate, or 9,10-dihydro-9-oxa-10-phosphaphenantrene 10-oxide and, acting as IR absorber, non-expandable graphite with an average particle size in the range from 0.1 to 100 μm, in amounts of from 0.1 to 5% by weight, based in each case on styrene polymer.

The layer-lattice structure of graphite permits it to form specific types of intercalation compounds. In these intercalation compounds, foreign atoms or foreign molecules have been absorbed, sometimes in stoichiometric ratios, into the spaces between the carbon atoms. These graphite compounds, e.g. using sulfuric acid as foreign molecule, are also produced on an industrial scale and are termed expandable graphite. The density of this expandable graphite is in the range from 1.5 to 2.1 g/cm³, and the average particle size is generally and advantageously from 10 to 1000 μμm, in the present case preferably from 20 to 500 μm, and in particular from 30 to 300 μm.

Phosphorus compounds which may be used are inorganic or organic phosphates, phosphites, or phosphonates, and also red phosphorus. Examples of preferred phosphorus compounds are diphenyl phosphate, triphenyl phosphate, diphenyl cresyl phosphate, ammonium polyphosphate, resorcinol diphenyl phosphate, melamine phosphate, dimethyl phenylphosphonate, or dimethyl methylphosphonate.

To prepare the inventive expandable styrene polymers, the blowing agent is mixed into the polymer melt. The process encompasses the stages of a) melt production, b) mixing, c) cooling, d) transport, and e) pelletizing. Each of these stages may be executed using the apparatus or combinations of apparatus known from plastics processing. Static or dynamic mixers, such as extruders, are suitable for this mixing process. The polymer melt may be taken directly from a polymerization reactor, or produced directly in the mixing extruder, or in a separate melting extruder via melting of polymer pellets. The cooling of the melt may take place in the mixing assemblies or in separate coolers. Examples of pelletizers which may be used are pressurized underwater pelletizers, the pelletizer with rotating knives and cooling via spray-misting of temperature-control liquids, or pelletizers involving atomization. Examples of suitable arrangements of apparatus for carrying out the process are:

a) polymerization reactor-static mixer/cooler-pelletizer

b) polymerization reactor-extruder-pelletizer

c) extruder-static mixer-pelletizer

d) extruder-pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent by from 20 to 100° C. This avoids polymer deposits in the dies and ensures problem-free pelletization.

In order to obtain marketable pellet sizes, the diameter (D) of the die holes at the discharge from the die should be in the range from 0.2 to 1.5 mm, preferably in the range from 0.3 to 1.2 mm, particularly preferably in the range from 0.3 to 0.8 mm. Even after die swell, this permits controlled setting of pellet sizes below 2 mm, in particular in the range from 0.4 to 1.4 mm.

Die swell can be affected not only by the molecular weight distribution but also by the geometry of the die. The die plate preferably has holes with an UD ratio of at least 2, where the length (L) indicates that region of the die whose diameter is at most the diameter (D) at the discharge from the die. The UD ratio is preferably in the range from 3 -20.

The diameter (E) of the holes at the entry to the die in the die plate should generally be at least twice as large as the diameter (D) at the discharge from the die.

One embodiment of the die plate has holes with conical inlet and an inlet angle α smaller than 180°, preferably in the range from 30 to 120°. In another embodiment, the die plate has holes with a conical outlet and an outlet angle β smaller than 90°, preferably in the range from 15 to 45°. In order to produce controlled pellet size distributions in the styrene polymers, the die plate may be equipped with holes of different discharge diameter (D). The various embodiments of die geometry may also be combined with one another.

One particularly preferred process for preparing expandable styrene polymers encompasses the steps of
a) polymerization of styrene monomer and, where appropriate, of copolymerizable monomers,
b) devolatilization of the resultant styrene polymer melt,
c) using a static or dynamic mixer at a temperature of at least 150° C., preferably from 180 to 260° C., to incorporate the blowing agent and, where appropriate, additives into the styrene polymer melt,
d) cooling the styrene polymer melt comprising blowing agent to a temperature of at least 120° C., preferably from 150 to 200° C.,
e) addition of the filler,
f) discharge via a die plate with holes whose diameter at the discharge from the die is at most 1.5 mm, and
g) pelletizing the melt comprising blowing agent.

The pelletizing process in step g) may take place directly downstream of the die plate under water at a pressure in the range from 1 to 25 bar, preferably from 5 to 15 bar.

Variable counterpressure in the underwater pelletizer permits controlled production of either compact or else incipiently foamed pellets. Even when nucleating agents are used, the incipient foaming at the underwater pelletizer dies remains controllable.

Pelletization of gasified melts or gasified polymer extrudates markedly above their glass temperature represents a challenge for the production of compact pellets, because incipient foaming is often difficult to suppress. This applies in particular in the presence of nucleating agents, such as inorganic or organic solid particles, or phase boundaries in blends.

Use of a pressurized underwater pelletizer using pressures in the range from 1 to 40 bar, in particular in the range from 4 to 20 bar, solves the problem. Furthermore, incipient foaming of the pellets can not only be completely suppressed (compact pellets) even in the presence of nucleating agents, but can also be controlled with precision (pellets with slight incipient foaming, bulk density from 40 to 550 g/l).

In the case of the compact pellets, prefoaming takes place (if appropriate after coating) in a current of steam to give foam beads with a density which is usually from 10 to 50 kg/m³, and the material is placed in intermediate storage for 24 hours and then fuzed in gas-tight molds, using steam, to give foams.

In order to achieve particularly low bulk densities, this foaming procedure may be repeated at least once, and the pellets here are usually placed in intermediate storage, and sometimes dried, between the foaming steps. The dry, incipiently foamed pellets may be further foamed in steam or in a gas mixture which comprises at least 50% by volume of water, preferably at temperatures in the range from 100 to 130° C., to give even lower densities. The desired bulk densities are below 25 g/l, in particular from 8 to 16 g/l.

Because of the polymerization in stage a) and devolatilization in stage b), a polymer melt is directly available for blowing agent impregnation in stage c), and no melting of styrene polymers is necessary. This is not only more cost-effective, but also gives expandable styrene polymers (EPSs) with low styrene monomer contents, because it avoids exposure to mechanical shear in the homogenizing section of an extruder-exposure which generally leads to breakdown of polymers to give monomers. In order to keep the styrene monomer content low, in particular below 500 ppm, it is also advantageous to minimize the amount of mechanical and thermal energy introduced in all of the subsequent stages of the process. Particular preference is therefore given to shear rates below 50/sec, preferably from 5 to 30/sec, and temperatures below 260° C., and also to short residence times in the range from 1 to 20 minutes, preferably from 2 to 10 minutes, in stages c) to e). It is particularly preferable to use exclusively static mixers and static coolers in the entire process. The polymer melt may be transported and discharged via pressure pumps, e.g. gear pumps.

Another method of reducing styrene monomer content and/or amount of residual solvent, such as ethylbenzene, consists in providing a high level of devolatilization in stage b), using entrainers, such as water, nitrogen, or carbon dioxide, or carrying out the polymerization stage a) by an anionic route. Anionic polymerization of styrene not only gives styrene polymers with low styrene monomer content but also gives very low styrene oligomer contents.

To improve processability, the finished expandable pelletized styrene polymer materials may be coated by glycerol esters, antistatic agents, or anticaking agents.

The inventive expandable pelletized styrene polymer materials (EPSs) have relatively high bulk densities, depending on the type of filler and filler content, generally in the range from 590 to 1200 g/l.

The inventive expandable pelletized thermoplastic polymer materials have good expansion capability, even when the content of blowing agent is very low. Even without any coating, susceptibility to caking is markedly lower than for conventional EPS beads.

The inventive expandable pelletized styrene polymer materials may be prefoamed by means of hot air or steam to give moldable foams with a density in the range from 8 to 200 kg/m³, preferably in the range from 10 to 50 kg/m³, and then may be fused in a closed mold to give foams.

### EXAMPLES

### Inventive Examples 1 to 17

The inventive examples used a polystyrene melt composed of PS VPT from BASF Aktiengesellschaft with a viscosity number VN of 75 ml/g (M_{w}=185 000 g/mol, polydispersity M_{w}/Mₙ=2.6), into which 6% by weight of n-pentane, based on the entire polymer melt, had also been incorporated by mixing. In examples 1 to 3, only 4% by weight of n-pentane was admixed.

Fillers used were:

chalk: Ulmer Weiss XM, Omya GmbH; average particle diameter 4.8 μm

kaolin: B22 kaolin, Blancs Mineraux

talc: Finntalc, Finnminerals; 99% of the particles below 20 μm

aluminum hydroxide: Apral 15, Nabaltec GmbH

glass microbeads: PA glass microbeads, Potters-Ballotini GmbH

The melt mixture comprising blowing agents was cooled in the cooler from an initial 260° C. to 190° C. At the outlet of the cooler, a filled polystyrene melt was metered in by way of an ancillary-feed extruder, thus setting the proportion by weight, based on the pelletized material, to that given in table 1 for the particular filler. The filled polystyrene melt was passed at 60 kg/h throughput through a die plate with 32 holes (die diameter 0.75 mm). A compact pelletized material with narrow size distribution was prepared with the aid of a pressurized underwater pelletizer. The pentane contents measured in the pelletized material after pelletization and after 14 days of storage are shown in table 1.

These pelletized materials were prefoamed in a current of steam to give foam beads whose density was 20 g/l, kept in intermediate storage for 12 hours, and then fused in gas-tight molds, using steam, to give foams.

Comparative Experiment:

The comparative experiment was carried out in the same way as inventive examples 1-17, but without addition of fillers.

To assess fire performance, a Bunsen burner flame was applied to the foam molding for a period of 2 seconds. Whereas the foam molding produced in the comparative experiment was consumed by combustion, the foam molding obtained in example 17 was self-extinguishing.

TABLE 1

| | | | Pentane | Pentane |
|---|---|---|---|---|
| | | [% by | content | content 14d |
| Example | Filler | weight] | [% by weight] | [% by weight] |
| CE1 | — | | 5.3 | 5.1 |
| 1 | Talc | 10 | 3.7 | 3.6 |
| 2 | Talc | 20 | 3.7 | 3.6 |
| 3 | Talc | 30 | | |
| 4 | Chalk | 10 | 5.3 | 5.2 |
| 5 | Chalk | 15 | 5.3 | 4.7 |
| 6 | Chalk | 20 | 5.1 | 4.4 |
| 7 | Kaolin | 10 | 5.3 | 5.2 |
| 8 | Kaolin | 20 | 5.3 | 5.1 |
| 9 | Glass beads | 10 | 5.3 | |
| 10 | Glass beads | 20 | 5.1 | |
| 11 | Starch | 10 | | |
| 12 | Starch | 20 | | |
| 13 | Wood flour | 5 | | |
| 14 | Wood flour | 10 | | |
| 15 | Cinders | 10 | | |
| 16 | Cinders | 20 | | |
| 17 | Aluminum | 10 | | |
| | hydroxide | | | |

TABLE 2
Expansion capability of pelletized materials (bulk density [g/l])

| Foaming time | | | | | | | | | | | | |
|---|---|---|---|---|---|---|---|---|---|---|---|---|
| [sec] | CE1 | IE1 | IE2 | IE3 | IE4 | IE5 | IE6 | IE7 | IE8 | IE9 | IE10 | IE17 |
| 1 | | | | | 20.8 | 23.8 | 25.0 | 25.0 | 23.8 | 27.8 | 22.7 | 19.2 |
| 2 | 22.7 | | | | 15.6 | 16.7 | 18.5 | 16.7 | 16.7 | 15.6 | 19.2 | 17.2 |
| 3 | 17.9 | | | 33.3 | 17.2 | 16.7 | 19.2 | 17.2 | 18.5 | 16.1 | 20.8 | 16.7 |
| 4 | 15.6 | | | 29.4 | 20.8 | 17.9 | 23.8 | 19.2 | 20 | 17.2 | 21.7 | 17.2 |
| 5 | 15.2 | 25 | | 29.4 | 22.7 | 18.5 | | | | | | 17.9 |
| 6 | 14.7 | 22.7 | 25.0 | 31.3 | | 19.2 | | | | | | 18.5 |
| 7 | 16.1 | 21.7 | | | | | | | | | | |
| 8 | | 22.7 | 22.7 | 35.8 | | | | | | | | |
| 10 | | | 22.7 | 38.5 | | | | | | | | |
| 12 | | | 23.8 | | | | | | | | | |

For determination of the susceptibility to caking, the prefoamed beads were placed on a coarse-meshed sieve, and the proportion remaining on the sieve was determined.

TABLE 3
Susceptibility to caking

Example

| | CE | 4 | 5 | 7 |
|---|---|---|---|---|
| Susceptibility | 3.0 | 0.2 | 0.3 | 0.1 |
| to caking [% by | | | | |
| weight] | | | | |

To assess the fusion of the foam beads, a test specimen foam, thickness 4 cm, was broken apart, and the proportion of fractured foam beads and intact beads on the fracture surface was determined. The fracture fusion factor characterizes the coherence of the beads and is therefore a measure of mechanical properties such as flexural performance. Surface quality (cavities, interstices) was assessed as shown in table 4. The proportion of closed cells was determined from scanning electron micrographs (SEMs) of the foams.

TABLE 4
Properties of foam moldings

| Example | Fusion [%] | Surface | Proportion of closed cells [%] |
|---|---|---|---|
| CE | 90 | good | 95 |
| 2 | 70 | satisfactory | 85 |
| 4 | 90 | good | 90 |
| 7 | 85 | good | 90 |
| 9 | 90 | good | 90 |

### Inventive Examples 1a, 5a, 7a, and 14a

Inventive examples 1a, 5a, 7a, and 14a were carried out in the same way as examples 1, 5, 7, and 14, but with addition of 1% by weight of a styrene-maleic anhydride copolymer with 12% by weight of maleic anhydride (Dylark®) as adhesion promoter. Table 4 shows the compressive strengths of the foam moldings.

TABLE 4
Compressive strengths of foam moldings

| Example | without Dylark ® | with 1% by weight of Dylark ® |
|---|---|---|
| CE | +/− | +/− |
| 1, 1a | +/− | + |
| 5, 5a | − | + |
| 7, 7a | + | + |
| 14, 14a | +/− | + |

Assessment of Compressive Strength:

±: comparable with VPT without filler

−: very slightly poorer compressive strength

−−: markedly impaired compressive strength

+: improved compressive strength

++: markedly improved compressive strength

### Inventive Examples 18 -20 and Comparative Experiments C2, C3

7% by weight, based on polystyrene, of pentane were mixed in an extruder into a polystyrene melt composed of PS 158 K from BASF Aktiengesellschaft with a viscosity number VN of 98 ml/g (M_{w}=280 000 g/mol, polydispersity M_{w}/Mₙ=2.8). Once the melt containing blowing agent had been cooled from an initial 260° C. to a temperature of 190° C., a mixture composed of polystyrene melt, filler (chalk, UlmerWeiβ (Omya)), IR absorber (carbon black or graphite, UF298 Kropfmühl), and flame retardant (HBCD) were added as in table 1 by way of an ancillary extruder and mixed into the main stream. In addition, the flame retardant synergist dicumyl (DC) or dicumyl peroxide dissolved in pentane metered into the cooled main stream by way of a metering lance and by means of a piston pump, at an axial position corresponding to that of the ancillary extruder.

The mixture composed of polystyrene melt, blowing agent, flame retardant, and synergist was conveyed at 60 kg/h through a die plate with 32 perforations (die diameter 0.75 mm). Pressurized underwater pelletization produced compact pellets with a narrow size distribution.

These pellets were prefoamed in a current of steam to give foam beads (20 g/l), kept in intermediate storage for 24 hours, and then fused in gas-tight molds, using steam, to give foams.

Afterflame times below 6 seconds are suitable for passing the DIN 4102 B2 test.

TABLE 6

| | | | | Flame | | Coefficient | After- |
|---|---|---|---|---|---|---|---|
| | | | | retardant | Density | of thermal | flame |
| | Filler | IR absorber | HBCD | synergist | of foam | conductivity | time |
| Ex | [% by weight] | [% by weight] | [% by weight] | [% by weight] | [kg/m³] | [mW/mK] | [sec] |
| C2 | 10 | | 1.2 | 0.3 DCP | 20.4 | 32.7 | 5 |
| C3 | 20 | | 2.0 | 0.4 DC | 23.9 | 31.5 | 6 |
| 18 | 10 | 0.5 graphite | 2.0 | 0.4 DCP | 17.1 | 31.9 | 3 |
| 19 | 10 | 1.0 carbon | 2.0 | 0.3 DCP | 18.8 | 32.0 | 3 |
| | | black | | | | | |
| 20 | 5 | 4 graphite | 2.5 | 0.4 DCP | 12.9 | 30.9 | 4 |

### Inventive Examples 21 -23

### Inventive Example 21

The polystyrene melt used for the example was composed of PS 148G from BASF Aktiengesellschaft with a viscosity number VN of 83 ml/g (M_{W}=220 000 g/mol, polydispersity M_{w}/Mₙ=2.8), into which 7% by weight of n-pentane and 0.3% by weight of water had been mixed. Once the melt containing blowing agent had been cooled from an initial 260° C. to a temperature of 190° C., the mixture composed of polystyrene melt and blowing agent was conveyed at 60 kg/h through a die plate with 32 perforations (die diameter 0.75 mm). Pressurized underwater pelletization (4 bar) produced incipiently foamed pellets (bulk density 550 kg/m³) with a narrow size distribution.

### Inventive Example 22

The polystyrene melt used for the example was composed of PS 148G from BASF Aktiengesellschaft with a viscosity number VN of 83 ml/g (M_{W}=220 000 g/mol, polydispersity M_{w}/Mₙ=2.8), into which 7% by weight of n-pentane and 10% by weight of chalk had been mixed. Once the melt containing blowing agent had been cooled from an initial 260° C. to a temperature of 190° C., a mixture composed of polystyrene melt and filler was conveyed in the ancillary stream (extruder) and mixed into the main stream so that the final product comprised 10% by weight of filler. The mixture composed of polystyrene melt, blowing agent and filler was conveyed at 60 kg/h through a die plate with 32 perforations (die diameter 0.75 mm). Pressurized underwater pelletization (12 bar) produced compact pellets with a narrow size distribution.

### Inventive Example 23

The polystyrene melt used for the example was composed of PS 148G from BASF Aktiengesellschaft with a viscosity number VN of 83 ml/g (M_{W}=220 000 g/mol, polydispersity M_{w}/Mₙ=2.8), into which 7% by weight of n-pentane, 0.3% by weight of water and 10% by weight of chalk had been mixed. Once the melt containing blowing agent had been cooled from an initial 260° C. to a temperature of 190° C., the filler was added by way of an ancillary extruder in the form of a polystyrene melt mixture and mixed into the main stream so that the final product comprised 10% by weight of filler. The mixture composed of polystyrene melt, blowing agent and filler was conveyed at 60 kg/h through a die plate with 32 perforations (die diameter 0.75 mm). Pressurized underwater pelletization (4 bar) produced incipiently foamed pellets (380 kg/m³) with a narrow size distribution.

### Inventive Examples 24 -27

7% by weight of n-pentane were mixed into a polystyrene melt composed of PS 148G from BASF Aktiengesellschaft with a viscosity number VN of 83 ml/g (M_{W}=220 000 g/mol, polydispersity M_{w}/Mₙ=2.9). Once the melt containing blowing agent had been cooled from an initial 260° C. to a temperature of 190° C., a polystyrene melt was added by way of an ancillary extruder and the fillers (chalk) mentioned in table 1 and the appropriate flame retardant mixture (expandable graphite: ES 350 F5 from Kropfmühl, red phosphorus, triphenyl phosphate (TPP) or 9,10-dihydro-9-oxa-10-phosphaphenanthrene-10-oxide (DOP)) and was mixed into the main stream. The stated amounts in % by weight are based on the entire amount of polystyrene.

The mixture composed of polystyrene melt, blowing agent, filler, and flame retardant was conveyed at 60 kg/h through a die plate with 32 perforations (die diameter 0.75 mm). Pressurized underwater pelletization produced compact pellets with a narrow size distribution.

These pellets were prefoamed in a current of steam to give foam beads (10-15 g/l), kept in intermediate storage for 24 hours, and then fused in gas-tight molds, using steam, to give foams.

Prior to testing for fire performance and thermal conductivity, the test specimens were stored for at least 72 hours. Inventive examples 1-4 were self-extinguishing and passed the DIN 4102 B2 fire test.

TABLE 7

| | | Expandable | | | Coefficient |
|---|---|---|---|---|---|
| | Chalk | graphite | Phosphorus | | of thermal |
| Ex- | [% by | [% by | (compound) | Density | conductivity |
| ample | weight] | weight] | [% by weight] | [kg/m³] | [mW/m * K] |
| 24 | 5 | 6 | 4 red | 12.5 | 36.0 |
| | | | phosphorus | | |
| | | | 1.5 TPP | | |
| 25 | 10 | 6 | 6 red | | |
| | | | phosphorus | | |
| 26 | 5 | 10 | 6 TPP | 12.7 | 34.5 |
| 27 | 5 | 6 | 6 DOP | | |

1. A moldable-foam molding with a density from 8 to 200 g/l, obtainable via fusion of prefoamed foam beads comprising expandable pelletized thermoplastic polymer materials, wherein the pelletized polymer materials comprise from 1 to 50% by weight, of one or more fillers selected from the group consisting of talc, chalk, kaolin, aluminum hydroxide, magnesium hydroxide, aluminum nitrite, aluminum silicate, calcium carbonate, calcium sulfate, silica, powdered quartz, Aerosil, alumina and glass beads.

2. The moldable-foam molding according to claim 1, wherein the prefoamed foam beads include cells of which more than 80% are of closed-cell type.

3. The moldable-foam molding according to claim 1 wherein the polymer materials include a styrene polymer.

4. The moldable-foam molding according to claim 1, wherein the filler is present from 5 to 30% by weight.

5. The moldable foam molding according to claim 1, wherein the filler has an average particle diameter in the range from 1 to 50 μm.

6. The moldable foam molding according to claim 1, further comprising from 0.1 to 10% by weight of carbon black or graphite.

7. An expandable pelletized thermoplastic polymer material which comprises from 5 to 50% by weight of one or more fillers selected from the group consisting of talc, chalk, kaolin, aluminum hydroxide, aluminum nitrite, aluminum silicate, calcium carbonate, calcium sulfate, silica, powdered quartz, Aerosil, alumina and glass beads.

8. The expandable pelletized thermoplastic polymer material according to claim 7,
further comprising from 2 to 40% by weight of expandable graphite with an average particle size from 10 to 1000 μm,
from 0 to 20% by weight of red phosphorus or an organic or inorganic phosphate, phosphite or phosphonate,
from 0 to 10% by weight of carbon black or graphite.

9. The expandable pelletized thermoplastic polymer material according to claim 7, which comprises from 3 to 7% by weight of an organic blowing agent.

10. A process for preparing expandable pelletized thermoplastic polymer materials, comprising the steps of
a) incorporating an organic blowing agent and from 5 to 50% by weight of a filler into a polymer melt using a static or dynamic mixer at a temperature of at least 150° C.,
b) cooling the polymer melt to a temperature of 120° C. or less,
c) discharge via a die plate with holes whose diameter is at most 1.5 mm, and
d) pelletizing the melt downstream of the die plate under water at a pressure from 1 to 20 bar.

11. A process for producing moldable-foam moldings according to claim 1, which comprises using hot air or steam to prefoam expandable pelletized thermoplastic polymer materials comprising 5 to 50% by weight of one or more fillers selected from the group consisting of talc, chalk, kaolin, aluminum hydroxide, aluminum nitrite, aluminum silicate, calcium carbonate, calcium sulfate, silica. powdered quartz, Aerosil, alumina and glass beads in a first step to give foam beads whose density is in the range from 8 to 200 g/l, and fusing the material in a second step in a closed mold.

12. The moldable foam molding according to claim 4, wherein the filler has an average particle diameter from 1 to 50 μm.

13. A moldable-foam molding prepared by a process comprising:
providing prefoamed foam beads, wherein the foam beads comprise polymer materials and from 5 to 30% by weight of one or more fillers selected from the group consisting of talc, chalk, kaolin, aluminum hydroxide, magnesium hydroxide, aluminum nitrite, aluminum silicate, calcium carbonate, calcium sulfate, silica, powdered quartz, Aerosil, alumina and glass beads, the prefoamed foam beads having been exposed using hot air or steam; and
fusing the prefoamed foam beads in a closed mold, wherein the density of the molding is from 8 to 200 g/l.

14. The moldable-foam molding according to claim 13, wherein the preformed foam beads include cells of which more than 80% are of closed-cell type.

15. The moldable-foam molding according to claim 13, wherein the polymer materials are styrene-based materials, and the filler has an average particle diameter of from 1 to 50 μm.

16. The moldable-foam molding according to claim 13, wherein the prefoamed foam beads comprise 2 to 40% by weight of expanded graphite with an average particle size from 10 to 1,000 μm.

17. The moldable-foam molding according to claim 13, further comprising 0.1 to 10% by weight of carbon black or graphite.
